(19) United States
(12) Patent Application Publication
(10) Pub. No.: US 2013/0149591 A1
(43) Pub. Date: Jun. 13, 2013

(54) SECONDARY BATTERY MODULE

(71) Applicant: SB Limotive Co., Ltd., Yongin-City (KR)

(72) Inventors: Sangwon BYUN, Yongin-City (KR); Haekwon YOON, Yongin-City (KR); Zin PARK, Yongin-City (KR)

(73) Assignee: SB LIMOTIVE CO., LTD., Yongin-City (KR)

(21) Appl. No.: 13/707,296

(22) Filed: Dec. 6, 2012

(30) Foreign Application Priority Data
Dec. 12, 2011 (KR) 10-2011-0133286

(51) Int. Cl. H01M 2/10

(52) U.S. Cl. CPC H01M 2/1077
USPC 429/159

(57) ABSTRACT

A secondary battery module including a plurality of battery cells arranged in a direction, and a pair of end plates contacting outermost surfaces of the plurality of battery cells, and each of the pair of end plates includes an inclined plane. The secondary battery module maintains a stacked structure of the plurality of battery cells in a secure manner when an external force is applied, while minimizing or reducing damage of the battery cells.

### CROSS-REFERENCE TO RELATED APPLICATION

This application claims priority to and the benefit of Korean Patent Application No. 10-2011-0133286, filed on Dec. 12, 2011 in the Korean Intellectual Property Office, the entire content of which is incorporated herein by reference.

### BACKGROUND

1. Field

Aspects of embodiments of the present invention relate to a secondary battery module.

2. Description of the Related Art

Generally, a large-capacity secondary battery module includes a plurality of battery cells connected to each other in series or parallel.

Each of the battery cells includes an electrode assembly having a positive electrode and a negative electrode positioned with a separator interposed therebetween, a case accommodating the electrode assembly, a cap plate coupled to the case and sealing the case, and a positive electrode terminal and a negative electrode terminal protruding from the cap plate and electrically connected to the electrode assembly.

In the secondary battery module, the respective battery cells are alternately arranged such that positive electrode terminals and negative electrode terminals of adjacent battery cells are alternated with each other and electrically connected to each other by bus bars.

In addition, the secondary battery module has a plurality of battery cells arranged in a line and two end plates positioned on the outermost surfaces of the battery cells, and the end plates are coupled to each other by a connection member, thereby fixing the plurality of battery cells in a secure manner.

However, a secondary battery module may be susceptible to damage of battery cells by distributing an externally applied force. Also, if the external force is applied to the end plates of the secondary battery module, the force applied to the battery cells may not be appropriately distributed.

### SUMMARY

According to an aspect of embodiments of the present invention, a secondary battery module is configured to maintain a stacked structure of battery cells in a secure manner when an external force is applied, while minimizing or reducing damage of the battery cells.

According to one embodiment, a secondary battery module includes a plurality of battery cells arranged in a direction, and a pair of end plates contacting outermost surfaces of the plurality of battery cells, and each of the pair of end plates includes an inclined plane.

Each of the pair of end plates may include an inner surface contacting a respective one of the outermost surfaces; the inclined plane opposite the inner surface; a top surface connecting the inner surface and the inclined plane; a bottom surface opposite and substantially parallel with the top surface; a first side surface connecting the inner surface, the inclined plane, the top surface, and the bottom surface; and a second side surface opposite and substantially parallel with the first side surface, wherein the inclined plane is inclined from one side to another side.

The top surface and the bottom surface may be trapezoidal.

The pair of end plates may include a first end plate contacting a first outermost surface of the outermost surfaces at a first end of the plurality of battery cells; and a second end plate contacting a second outermost surface of the outermost surfaces at a second end of the plurality of battery cells opposite the first end.

The inclined plane of the first end plate and the inclined plane of the second end plate may be parallel with each other.

The inclined plane of the first end plate and the inclined plane of the second end plate may not be parallel with each other.

The inclined plane of the first end plate and the inclined plane of the second end plate may have a same angle of inclination with respect to the inner surfaces of the respective first and second end plates.

The inclined plane of the first end plate and the inclined plane of the second end plate may be symmetrical to each other with respect to the inner surfaces of the first and second end plates.

The inclined plane of the first end plate and the inclined plane of the second end plate may be inclined in a same direction with respect to the inner surfaces of the respective first and second end plates.

The inclined plane of the first end plate and the inclined plane of the second end plate may be inclined in different directions with respect to the inner surfaces of the respective first and second end plates.

The secondary battery module may be adapted for use as a motor-driving power source for propelling an electric vehicle or a hybrid electric vehicle.

According to an aspect of embodiments of the present invention, in a secondary battery module, a stacked structure of battery cells is maintained in a secure manner by installing end plates on opposite outermost surfaces of the battery cells.

According to another aspect of embodiments of the present invention, in a secondary battery module, since an inclined plane is further formed on each of the end plates, an external force applied to the end plate is distributed, and the external force transmitted to the battery cells is reduced accordingly, thereby minimizing or reducing damage of the battery cells. As such, a secondary battery module according to embodiments of the present invention is suited for application in an electric vehicle or a hybrid electric vehicle.

Additional aspects and/or advantages of the invention will be set forth in part in the description which follows and, in part, will be obvious from the description, or may be learned by practice of the invention.

### BRIEF DESCRIPTION OF THE DRAWINGS

The above and other features and aspects of the present invention will become more apparent to those of ordinary skill in the art by describing in detail some exemplary embodiments thereof with reference to the attached drawings, in which:

FIG. 1 is a perspective view of a secondary battery module according to an embodiment of the present invention;

FIG. 2 is a perspective view of an end plate of the secondary battery module of FIG. 1; and

FIG. 3 is a perspective view of a secondary battery module according to another embodiment of the present invention.

### DETAILED DESCRIPTION

Some exemplary embodiments of the present invention will be described more fully hereinafter with reference to the accompanying drawings; however, embodiments of the present invention may be embodied in different forms and should not be construed as limited to the exemplary embodiments illustrated and set forth herein. Rather, these exemplary embodiments are provided by way of example for understanding of the invention and to convey the scope of the invention to those skilled in the art. As those skilled in the art would realize, the described embodiments may be modified in various ways, all without departing from the spirit or scope of the present invention.

A secondary battery module according to an embodiment of the present invention is described below.

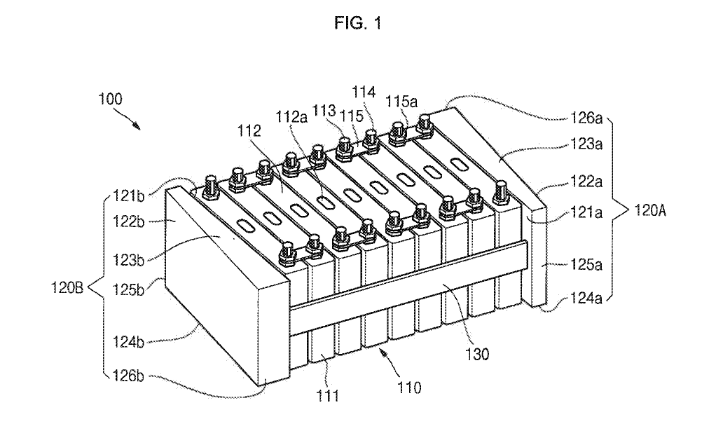

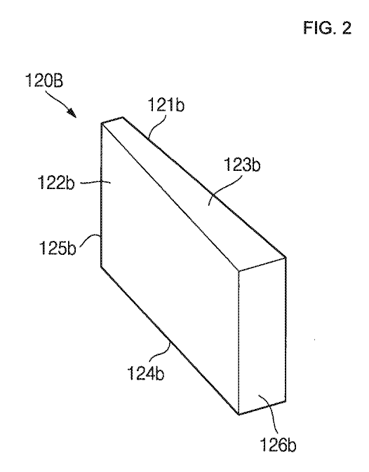

FIG. 1 is a perspective view of a secondary battery module according to an embodiment of the present invention, and FIG. 2 is a perspective view of an end plate of the secondary battery module shown in FIG. 1.

Referring to FIGS. 1 and 2, a secondary battery module 100 according to an embodiment of the present invention includes battery cells 110, end plates 120A and 120B, and a connection member 130.

The secondary battery module 100 according to an embodiment of the present invention includes a plurality of the battery cells 110 arranged in a direction (e.g., in a horizontal direction). The end plates 120A and 120B are positioned on outermost surfaces of the plurality of battery cells 110, respectively.

In one embodiment, the connection member 130 may be shaped as a rod or a bar, for example, and is coupled to the end plates 120A and 120B at opposite sides of the plurality of battery cells 110 arranged in a line, thereby fixing the battery cells 110 in a secured manner.

Inclined planes 122a and 122b are formed on outer surfaces of the end plates 120A and 120B. Thus, even if an external force is applied to the end plates 120A and 120B in a substantially perpendicular direction, the external force is effectively distributed, thereby minimizing or reducing damage of the battery cells 110.

In one embodiment, each of the battery cells 110 includes a case 111, a cap plate 112, a first electrode terminal 113, and a second electrode terminal 114, and the battery cells 110 are electrically connected to each other by bus bars 115.

The case 111, in one embodiment, is formed of aluminum, an aluminum alloy, or another conductive metal, such as nickel-plated steel, and has a generally hexahedral shape having an opening through which an electrode assembly (not shown) is inserted and received in the case 111. In one embodiment, an inner surface of the case 111 is insulated, thereby insulating the case 111 from the electrode assembly, the first electrode terminal 113, and the second electrode terminal 114.

The cap plate 112 seals the opening of the case 111 and may be formed of the same material as the case 111. In one embodiment, for example, the cap plate 112 may be coupled to the case 111 by laser welding. In one embodiment, the cap plate 112 may have a same polarity as the second electrode terminal 114, and the cap plate 112 and the case 111 may also have the same polarity. The cap plate 112, in one embodiment, has a safety vent 112a formed generally at a center region thereof and configured to be opened at a certain pressure (e.g., a predetermined pressure).

The first electrode terminal 113 is electrically connected to the electrode assembly and protrudes and extends a distance (e.g., a predetermined length) upwardly while penetrating the cap plate 112. The first electrode terminal 113 may be formed of a metal.

In one embodiment, the second electrode terminal 114 is electrically connected to the electrode assembly and protrudes and extends a distance (e.g., a predetermined length) upwardly while penetrating the cap plate 112. The second electrode terminal 114 may be formed of a metal. The first electrode terminal 113 may be a negative electrode and the second electrode terminal 114 may be a positive electrode, or vice versa.

In one embodiment, each of the bus bars 115 has through holes formed at opposite sides thereof. The through holes of the bus bar 115 are engaged with the first electrode terminals 113 and the second electrode terminals 114 of adjacent battery cells 110. The bus bars 115 connect the battery cells 110 to each other in series or in parallel. In one embodiment, the bus bars 115 engage the first electrode terminals 113 and the second electrode terminals 114 of adjacent battery cells 110 to be electrically connected to each other by means of nuts 115a.

The end plates 120A and 120B include a first end plate 120A and a second end plate 120B. The end plates 120A and 120B may be formed in a block or bulk type. In one embodiment, the end plates 120A and 1208 may be formed of a material selected from the group consisting of metals, plastics, engineering plastics, and equivalents thereof, but embodiments of the present invention are not limited to the materials of the end plates 120A and 120B listed herein.

The end plates 120A and 120B include the first end plate 120A contacting an outermost surface of one of the battery cells 110, and the second end plate 120B contacting the outermost surface of another one of the battery cells 110. The first end plate 120A contacts and is closely held against one surface of one of the battery cells 110, and the second end plate 120B contacts and is closely held against one surface of another one of the battery cells 110.

The first end plate 120A, in one embodiment, has an inner surface 121a, an inclined plane 122a, a top surface 123a, a bottom surface 124a, a first side surface 125a, and a second side surface 126a. In one embodiment, the top surface 123a and the bottom surface 124a of the first end plate 120A are substantially trapezoidal. The inclined plane 122a is inclined at an angle (e.g., a predetermined angle) with respect to the inner surface 121a.

The inner surface 121a contacts an outer surface of the outermost battery cell 110 at one side of the plurality of battery cells 110. In addition, the inclined plane 122a is formed on the surface (i.e. the outer surface) opposite the inner surface 121a. In one embodiment, the inclined plane 122a is inclined from one side to the other side.

The top surface 123a connects the inner surface 121a and the inclined plane 122a and, in one embodiment, is formed on a same plane as the cap plate 112 from which the first electrode terminal 113 and the second electrode terminal 114 protrude. The bottom surface 124a is positioned on a surface opposite the top surface 123a and, in one embodiment, the top surface 123a and the bottom surface 124a are formed to be parallel with each other.

The first side surface 125a connects the inner surface 121a, the inclined plane 122a, the top surface 123a, and the bottom surface 124a. The second side surface 126a is positioned on a surface opposite the first side surface 125a and, in one embodiment, is formed to be parallel with the first side surface 125a. In addition, like the first side surface 125a, the second side surface 126a connects the inner surface 121a, the inclined plane 122a, the top surface 123a, and the bottom surface 124a.

The second end plate 120B, in one embodiment, includes an inner surface 121b, an inclined plane 122b, a top surface 123b, a bottom surface 124b, a first side surface 125b, and a second side surface 126b. In one embodiment, the top surface 123b and the bottom surface 124b of the second end plate 120B are substantially trapezoidal. The inclined plane 122b is inclined at an angle (e.g., a predetermined angle) with respect to the inner surface 121b.

The inner surface 121b contacts an outer surface of the outermost battery cell 110 at a side of the plurality of battery cells 110 opposite the first end plate 120A. The inclined plane 122b is formed on the surface (i.e. the outer surface) opposite the inner surface 121b and, in one embodiment, is inclined from one side to the other side.

The top surface 123b connects the inner surface 121b and the inclined plane 122b and, in one embodiment, is formed on the same plane as the cap plate 112 from which the first electrode terminal 113 and the second electrode terminal 114 protrude. The bottom surface 124b is positioned on a surface opposite the top surface 123b and, in one embodiment, the top surface 123b and the bottom surface 124b are formed to be parallel with each other.

The first side surface 125b connects the inner surface 121b, the inclined plane 122b, the top surface 123b, and the bottom surface 124b. The second side surface 126b is positioned on a surface opposite the first side surface 125b and, in one embodiment, is formed to be parallel with the first side surface 125b. In addition, like the first side surface 125b, the second side surface 126b connects the inner surface 121b, the inclined plane 122b, the top surface 123b, and the bottom surface 124b.

In one embodiment, the inclined plane 122a of the first end plate 120A and the inclined plane 122b of the second end plate 120B may be formed to be parallel with each other. The inclined plane 122a of the first end plate 120A and the inclined plane 122b of the second end plate 120B may be inclined in opposite directions with respect to the respective inner surfaces 121a and 121b with the same angle of inclination. When the respective inner surfaces 121a and 121b are not taken into consideration, the inclined plane 122a of the first end plate 120A and the inclined plane 122b of the second end plate 120B may be inclined in the same direction.

As described above, since the inclined planes 122a and 122b are formed in the end plates 120A and 120B, safety of the secondary battery module 100 can be secured. Since the inclined planes 122a and 122b are formed in the end plates 120A and 120B, respectively, when an external force is applied to the end plates 120A and 120B in a substantially perpendicular direction, the external force is effectively distributed, thereby minimizing or reducing damage of the battery cells 110. As such, a secondary battery module according to embodiments of the present invention is suited for application in an electric vehicle or a hybrid electric vehicle.

The connection member 130, shaped as a bar or rod, for example, fixes the end plates 120A and 120B together, and the plurality of battery cells 110 are thereby fixed in a secured manner. The connection member 130 may include one or more connection members to connect the end plates 120A and 120B to each other, thereby fixing the plurality of battery cells 110 between the end plates 120A and 120B in a secured manner.

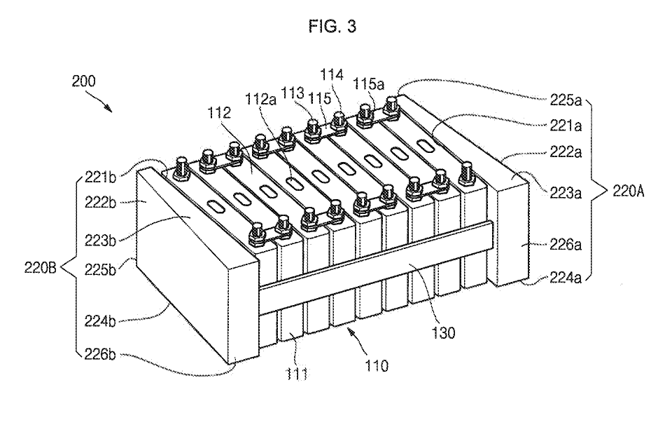

FIG. 3 is a perspective view of a secondary battery module according to another embodiment of the present invention.

Referring to FIG. 3, a secondary battery module 200 according to another embodiment of the present invention includes battery cells 110, end plates 220A and 220B, and the connection member 130.

The secondary battery module 200 has the end plates 220A and 220B arranged in a different manner than in the secondary battery module 100 described above and shown in FIGS. 1 and 2. Therefore, the secondary battery module 200 is described below with regard to the arrangement of the end plates 220A and 220B. In addition, components and features of the secondary battery module 200 which are the same or similar as those of the secondary battery module 100 described above and shown in FIGS. 1 and 2 are denoted by the same reference numerals and further detailed descriptions thereof will be omitted.

The end plates 220A and 220B of the secondary battery module 200 include a first end plate 220A and a second end plate 220B.

The first end plate 220A contacts an outer surface of an outermost one of the battery cells 110 at one side of the secondary battery module 200, and the second end plate 220B contacts an outer surface of another outermost one of the battery cells 110 at an opposite side of the secondary battery module 200.

The first end plate 220A, in one embodiment, includes an inner surface 221a, an inclined plane 222a, a top surface 223a, a bottom surface 224a, a first side surface 225a, and a second side surface 226a. In one embodiment, the top surface 223a and the bottom surface 224a of the first end plate 220A are substantially trapezoidal. The inclined plane 222a is inclined at an angle (e.g., a predetermined angle) with respect to the inner surface 221a.

The inner surface 221a contacts an outer surface of the outermost battery cell 110 at one side of the secondary battery module 200. In addition, the inclined plane 222a is formed on the surface (i.e. the outer surface) opposite the inner surface 221a and, in one embodiment, is inclined from one side to the other side.

The top surface 223a connects the inner surface 221a and the inclined plane 222a and, in one embodiment, is formed on the same plane as the cap plate 112 from which the first electrode terminal 113 and the second electrode terminal 114 protrude. The bottom surface 224a is positioned on a surface opposite the top surface 223a and, in one embodiment, the top surface 223a and the bottom surface 224a are formed to be parallel with each other.

The first side surface 225a connects the inner surface 221a, the inclined plane 222a, the top surface 223a, and the bottom surface 224a. The second side surface 226a is positioned on a surface opposite the first side surface 225a and, in one embodiment, is formed to be parallel with the first side surface 225a. Like the first side surface 225a, the second side surface 226a connects the inner surface 221a, the inclined plane 222a, the top surface 223a, and the bottom surface 224a.

The second end plate 220B, in one embodiment, includes an inner surface 221b, an inclined plane 222b, a top surface 223b, a bottom surface 224b, a first side surface 225b, and a second side surface 226b. In one embodiment, the top surface 223b and the bottom surface 224b of the second end plate 220B are substantially trapezoidal. The inclined plane 222b is inclined at an angle (e.g., a predetermined angle) with respect to the inner surface 221b.

The inner surface 221b contacts an outer surface of an outermost battery cell 110 at a side of the secondary battery module 200 opposite the first end plate 220A. In addition, the inclined plane 222b is formed on the surface (i.e. the outer surface) opposite the inner surface 221b and, in one embodiment, is inclined from one side to the other side.

The top surface 223b connects the inner surface 221b and the inclined plane 222b and, in one embodiment, is formed on the same plane as the cap plate 112 from which the first electrode terminal 113 and the second electrode terminal 114 protrude. The bottom surface 224b is positioned on a surface opposite the top surface 223b and, in one embodiment, the top surface 223a and the bottom surface 224a are formed to be parallel with each other.

The first side surface 225b connects the inner surface 221b, the inclined plane 222b, the top surface 223b, and the bottom surface 224b. The second side surface 226b is positioned on a surface opposite the first side surface 225b and, in one embodiment, is formed to be parallel with the first side surface 225b. In addition, like the first side surface 225a, the second side surface 226b connects the inner surface 221b, the inclined plane 222b, the top surface 223b, and the bottom surface 224b.

In one embodiment, the inclined plane 222a of the first end plate 220A and the inclined plane 222b of the second end plate 220B are symmetrical to each other with respect to the respective inner surfaces 221a and 221b. That is, the inclined plane 222a of the first end plate 220A and the inclined plane 222b of the second end plate 220B may be inclined in different directions at the same angle of inclination. Accordingly, in one embodiment, the inclined plane 222a of the first end plate 220A and the inclined plane 222b of the second end plate 220B are not parallel with each other.

As described above, since the inclined planes 222a and 222b are formed in the end plates 220A and 220B, safety of the secondary battery module 200 is secured. Since the inclined planes 222a and 222b are formed in the end plates 220A and 220B, respectively, when an external force is applied to the end plates 220A and 220B in a substantially perpendicular direction, the external force is effectively distributed, thereby minimizing or reducing damage of the battery cells 110.

Some exemplary embodiments of the present invention have been disclosed herein, and although specific terms are employed, they are used and are to be interpreted in a generic and descriptive sense only and not for purpose of limitation.

Accordingly, it will be understood by those of ordinary skill in the art that various changes in form and details may be made without departing from the spirit and scope of the present invention as set forth in the following claims.

What is claimed is:

1. A secondary battery module comprising:
a plurality of battery cells arranged in a direction; and
a pair of end plates contacting outermost surfaces of the plurality of battery cells,
wherein each of the pair of end plates comprises an inclined plane.

2. The secondary battery module of claim 1, wherein each of the pair of end plates includes:
an inner surface contacting a respective one of the outermost surfaces;
the inclined plane opposite the inner surface;
a top surface connecting the inner surface and the inclined plane;
a bottom surface opposite and substantially parallel with the top surface;
a first side surface connecting the inner surface, the inclined plane, the top surface, and the bottom surface; and
a second side surface opposite and substantially parallel with the first side surface,
wherein the inclined plane is inclined from one side to another side.

3. The secondary battery module of claim 2, wherein the top surface and the bottom surface are trapezoidal.

4. The secondary battery module of claim 2, wherein the pair of end plates includes:
a first end plate contacting a first outermost surface of the outermost surfaces at a first end of the plurality of battery cells; and
a second end plate contacting a second outermost surface of the outermost surfaces at a second end of the plurality of battery cells opposite the first end.

5. The secondary battery module of claim 4, wherein the inclined plane of the first end plate and the inclined plane of the second end plate are parallel with each other.

6. The secondary battery module of claim 4, wherein the inclined plane of the first end plate and the inclined plane of the second end plate are not parallel with each other.

7. The secondary battery module of claim 4, wherein the inclined plane of the first end plate and the inclined plane of the second end plate have a same angle of inclination with respect to the inner surfaces of the respective first and second end plates.

8. The secondary battery module of claim 4, wherein the inclined plane of the first end plate and the inclined plane of the second end plate are symmetrical to each other with respect to the inner surfaces of the first and second end plates.

9. The secondary battery module of claim 4, wherein the inclined plane of the first end plate and the inclined plane of the second end plate are inclined in a same direction with respect to the inner surfaces of the respective first and second end plates.

10. The secondary battery module of claim 4, wherein the inclined plane of the first end plate and the inclined plane of the second end plate are inclined in different directions with respect to the inner surfaces of the respective first and second end plates.

11. The secondary battery module of claim 1, wherein the secondary battery module is adapted for use as a motor-driving power source for propelling an electric vehicle or a hybrid electric vehicle.
